(19) United States
(12) Patent Application Publication
(10) Pub. No.: US 2005/0232421 A1
(43) Pub. Date: Oct. 20, 2005

(54) Secure logging of transactions

(75) Inventors: Paul R. Simons, Redhill (GB); David C. Yule, Taipei (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/525,482

(22) PCT Filed: Aug. 6, 2003
(86) PCT No.: PCT/IB03/03490

§ 371 Date: Feb. 23, 2005

(30) Foreign Application Priority Data
Aug. 28, 2002 (GB) 02199099

(51) Int. Cl. G06F 11/30; G06F 12/14

(52) U.S. Cl. 380/255

(57) ABSTRACT

A method of generating a secure transaction log recording transaction data established between a first 10 and a second 20 data processing device. The transaction log includes transaction data derived from the first device that is digitally signed by the second device, and then digitally re-signed by the first device, with copies being stored locally to both devices. Any interference with the data by either device, or during transfer of data between them is evident to both devices. The transaction data may include data received and signed by an independent third party as a trusted third party.

The present invention relates to the logging of transactions between two or more data processing devices, and in particular to establishing a secure log in respect of each transaction between the devices.

The use of digital signatures using public key cryptography to enable verification of the authenticity and integrity of data transmitted between first and second parties is well known.

A commonly used method is for the first party to apply a one-way hash function to the data that is to be conveyed to the second party. The resulting hash code can then be encrypted using the private key of the first party, and transmitted to the second party as a “signature” together with the original data. The second party can apply the same hash function to the original data and, having knowledge of the first party's public key can also decrypt the encrypted hash code (the “signature”) using the first party's public key. If the two versions of the hash code match, the second party can be confident (i) that the data does indeed come from the first party (ie. the authenticity is verified) and (ii) that the data has not been interfered with or corrupted en route (ie. the data integrity is verified).

There are a large number of applications and systems in which access control devices connected to computer networks provide secure control of access to certain functions by third party devices. The control is generally effected by the third party devices providing identification and other data (often encrypted) to the control devices which then establish from that data whether use of the function is authorised or not authorised.

A typical example of such a system is for physical access control to a large building using “smartcards” or “cardkeys”. In this system, personnel requiring access to the building each carry a cardkey that provides an identifying password (key) to entry point access control devices (eg. electronic locks) installed at each access control point of the building (eg. both external and internal access doors). The access control devices then determine, on the basis of received password keys, whether to grant access (eg. unlock the door).

It is often necessary or highly desirable to record all transactions between two devices, such as the cardkeys and the access control devices, SQ that the resulting transaction log may be used to establish who gained access to the building, at which access point, and when. Commonly, the access control devices would be connected to a central control computer where the transaction log would be stored.

In addition, it is often desirable not only that the transaction log records the verified identities of both parties, but also an agreed or verified time stamp.

It is an object of the present invention to provide a secure transaction logging system in which the transaction log can be verified for authenticity and data integrity by both devices that are party to the transaction. In this way, the transaction log can contain transaction data that has been verified by both devices that were party to the transaction.

It is a further object of the invention to provide a secure transaction logging system in which the transaction log can be verified for authenticity and data integrity by third parties having knowledge of the public keys of the devices that were party to a transaction.

It is a further object of the present invention to provide a secure transaction logging system in which data associated with the transaction, eg. time stamp data, may be recorded separately and securely as verified by both parties.

In this way, interference with either device, or with the data as it is transmitted to a central control computer, can be detected. In addition, theft of password data for use on a non-authorised device, or corruption of transaction data can also be detected.

According to one aspect, the present invention provides a method of generating a secure transaction log recording transaction data established between a first and a second data processing device, comprising the steps of:
the first device issuing a partial transaction log to the second device, the partial transaction log including identification data and event data associated with the transaction;
the second device issuing to the first device, in response to the partial transaction log, a signed full log, the signed full log including said identification data and event data, secured by a first digital signature specific to the second device; and
the first device issuing, in response to the signed full log, a re-signed full log including said identification data, said event data and said first digital signature, secured by a second digital signature specific to the first device.

According to another aspect, the present invention provides a method of operating an access control device to generate a secure transaction log recording transaction data established between a first device and the access control device, comprising the steps of:
receiving from the first device, a partial transaction log, the partial transaction log including identification data and event data associated with the transaction;
issuing to the first device, in response to the partial transaction log, a signed full log, the signed full log including said identification data and event data, secured by a first digital signature specific to the access control device; and
receiving, from the first device, in response to the signed full log, a re-signed full log including said identification data, said event data and said first digital signature, secured by a second digital signature specific to the first device.

According to another aspect, the present invention provides a method of operating a first data processing device to generate a secure transaction log recording transaction data established between the first device and a second data processing device, comprising the steps of:
issuing a partial transaction log to the second device, the partial transaction log including identification data and event data associated with the transaction;
receiving from the second device, in response to the partial transaction log, a signed full log, the signed full log including said identification data and event data, secured by a first digital signature specific to the second device; and
issuing, in response to the signed full log, a re-signed full log including said identification data, said event data and said first digital signature, secured by a second digital signature specific to the first device.

According to another aspect, the present invention provides apparatus for generating a secure transaction log recording transaction data established between a first and a second data processing device, comprising:
means, in the first device, for issuing a partial transaction log to the second device, the partial transaction log including identification data and event data associated with the transaction;
means, in the second device, for issuing to the first device, in response to the partial transaction log, a signed full log, the signed full log including said identification data and event data, secured by a first digital signature specific to the second device; and
means, in the first device, for issuing, in response to the signed full log, a re-signed full log including said identification data, said event data and said first digital signature, secured by a second digital signature specific to the first device.

According to another aspect, the present invention provides an access control device adapted to generate a secure transaction log recording transaction data established between a first device and the access control device, comprising:
means for receiving from the first device, a partial transaction log, the partial transaction log including identification data and event data associated with the transaction;
means for issuing to the first device, in response to the partial transaction log, a signed full log, the signed full log including said identification data and event data, secured by a first digital signature specific to the access control device; and
means for receiving, from the first device, in response to the signed full log, a re-signed full log including said identification data, said event data and said first digital signature, secured by a second digital signature specific to the first device.

According to another aspect, the present invention provides a data processing device adapted to generate a secure transaction log recording transaction data established between the data processing device and a second data processing device, comprising:
means for issuing a partial transaction log to the second device, the partial transaction log including identification data and event data associated with the transaction;
means for receiving from the second device, in response to the partial transaction log, a signed full log, the signed full log including said identification data and event data, secured by a first digital signature specific to the second device; and
means for issuing, in response to the signed full log, a re-signed full log including said identification data, said event data and said first digital signature, secured by a second digital signature specific to the data processing device.

Embodiments of the present invention will now be described by way of example and with reference to the accompanying drawings in which:

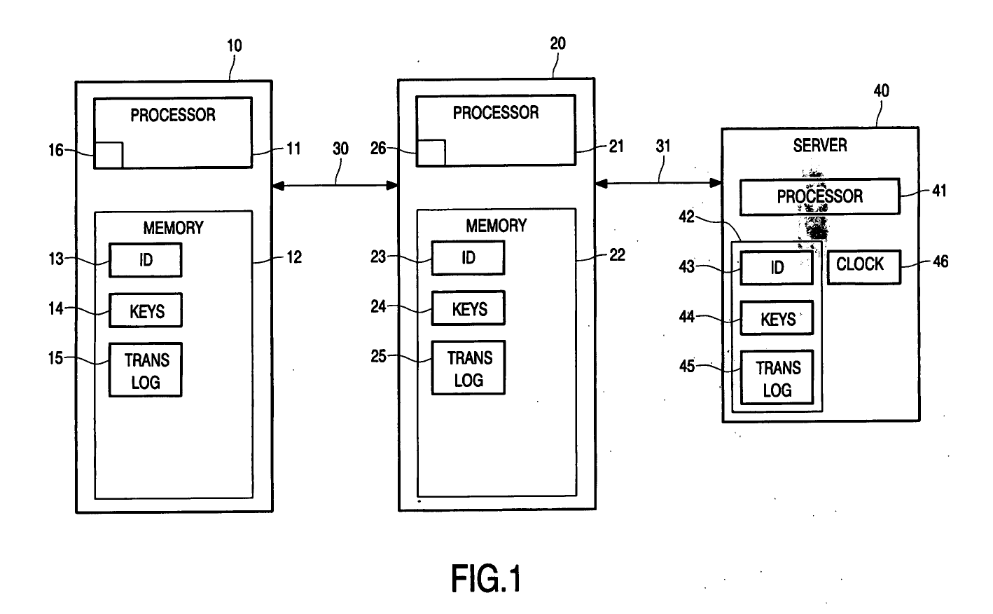

FIG. 1 shows a schematic block diagram of apparatus suitable for implementation of transaction logging procedures as described herein;

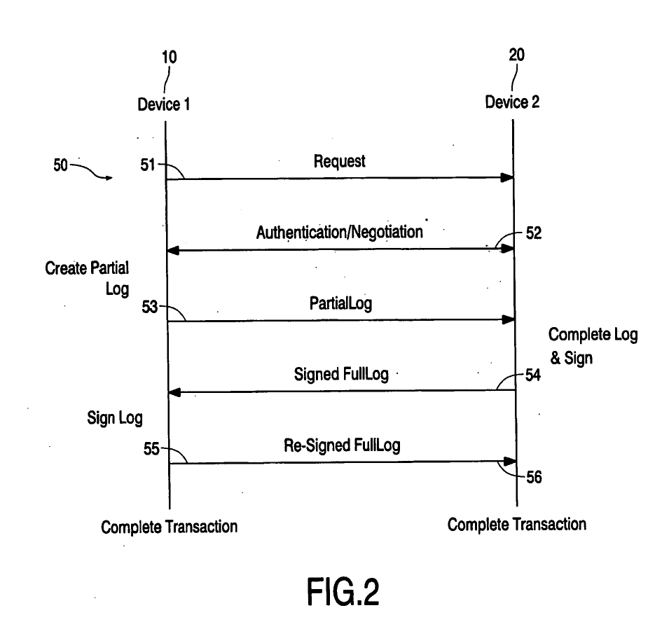

FIG. 2 shows a schematic flow diagram of a secure transaction logging procedure between two devices;

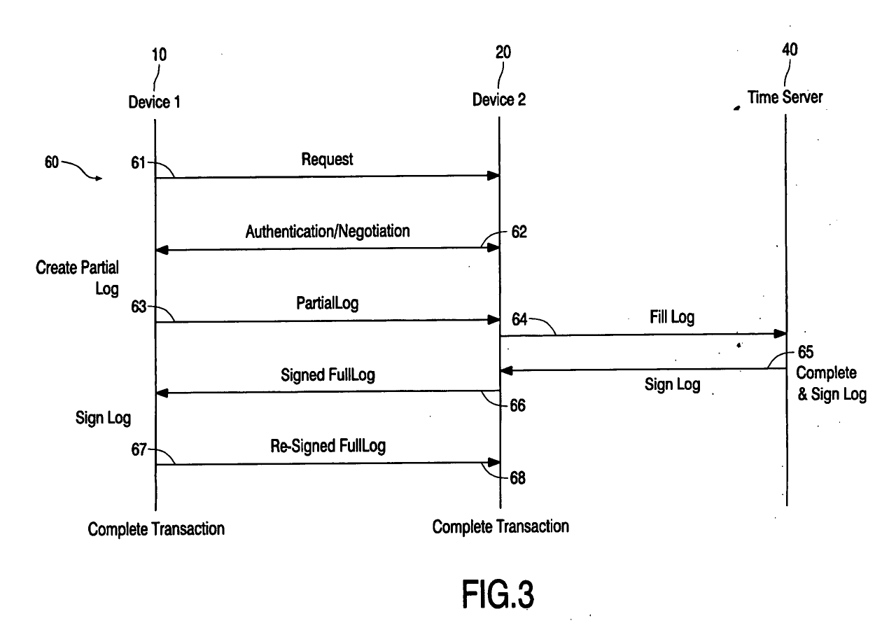

FIG. 3 shows a schematic flow diagram of a secure transaction logging procedure between three devices; and

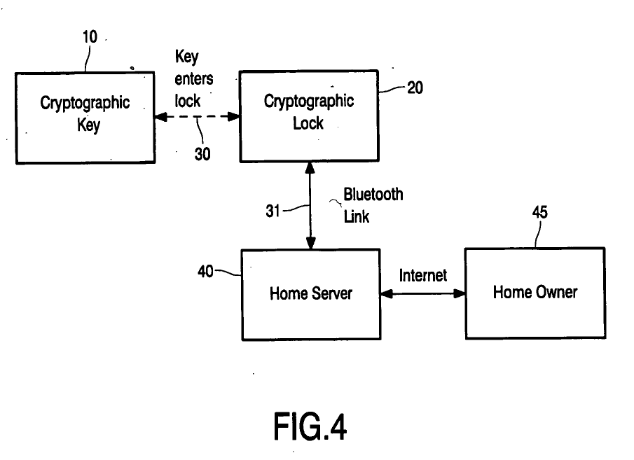

FIG. 4 shows a schematic diagram of apparatus for one application of the secure transaction logging process of FIG. 2.

With reference to FIG. 1, apparatus suitable for implementing a secure transaction logging process between at least two devices 10, 20 will now be described.

A first device 10 includes a processor 11 and a memory 12. The processor 11 is particularly configured to handle data processing transactions between the first and the second devices, including the application of a digital signature specific to the first device 10 to data transmitted to the second device 20. The processor 11 may, therefore, include a specific cryptographic engine, or the cryptographic functions may be performed by a general purpose processor.

The memory 12, which may be of any suitable type or types, includes storage capacity necessary for handling data processing transactions with the second device 20 or other device (not shown). In particular, the memory 12 preferably includes an identification data register 13 storing identification data by which the device 10 may be identified, and this may be in unencrypted or encrypted form. The memory 12 further preferably includes a key register 14 which contains the public keys of all other devices with which the device 10 may need to communicate, for decrypting digital signatures and/or encrypted communications thereof. The key register 14 may also include the private key specific to the device 10, for signing messages outgoing from the device.

The memory 12 preferably also includes a transaction log register 15 that maintains a log of all relevant transactions with other devices 20.

The first device may also include a real time or other clock 16. In general, the expression “clock” is intended to include any transaction counter or mechanism marking temporally spaced events in a time domain of the first device.

A second device 20 also includes a processor 21 and a memory 22. The processor 21 is also particularly configured to handle data processing transactions between the first and the second devices, including the application of a digital signature specific to the second device 20 to data transmitted to the first device 10. The processor 21 may, therefore, include a specific cryptographic engine, or the cryptographic functions may be performed by a general purpose processor.

The memory 22, which may be of any suitable type or types, includes storage capacity necessary for handling data processing transactions with the first device 20 or other devices (not shown). In particular, the memory 22 preferably includes an identification data register 23 storing identification data by which the device 20 may be identified, and this may be in unencrypted or encrypted form. The memory 22 further preferably includes a key register 24 which contains the public keys of all other devices with which the device 20 may need to communicate, for decrypting digital signatures thereof. The key register 24 may also include the private key specific to the device 20, for signing messages outgoing from the device.

The memory 22 preferably also includes a transaction log register 25 that maintains a log of all relevant transactions with other devices 10.

The second device may also include a real time or other clock 26. In general, the expression “clock” is intended to include any transaction counter or mechanism marking temporally spaced events in a time domain of the second device.

It will be understood that, although only two devices 10, 20 are illustrated, the principle of the transaction logging process can apply between any two or more devices in a group of devices.

The devices 10, 20 are adapted to communicate with one another over any suitable communications channel 30.

For example, the communications channel 30 may be a permanent or a transient direct electrical connection between the devices, or may be an optical, infrared, RF, electromagnetic or inductive link, for example in the case where one device 10 is a cardkey and the other device 20 is an electronic door lock. On the other hand, the communications channel 30 may be a permanent or transient network connection in the event that the devices are networkable computer systems.

In another embodiment, the second device 20 may be connected via a second communications channel 31 to a server 40 that may be used to insert third party data within transaction logs between the first and second devices 10, 20. The communications channel 31 may be any suitable means for transferring data, preferably a network, and more preferably the internet.

As previously described in connection with the first and second devices 10, 20, the server 40 preferably includes a processor 41 and a memory 42. The processor 41 is particularly configured to handle data processing transactions with the second (or other) devices 20, including the application of a digital signature specific to the server to secure data transmitted to the second device. The processor 41 may, therefore, include a specific cryptographic engine, or the cryptographic functions may be performed by a general purpose processor.

The memory 42, which may be of any suitable type or types, includes storage capacity necessary for handling data processing transactions with the second device 20 or other devices (not shown). In particular, the memory 42 preferably includes an identification data register 43 storing identification data by which the server 40 may be identified, and this may be in unencrypted or encrypted form. The memory 42 further preferably includes a key register 44 which contains the public keys of all other devices with which the server 40 may need to communicate, for decrypting digital signatures thereof. The key register 44 may also include the private key specific to the server 40, for signing messages outgoing from the server.

The memory 42 preferably also includes a transaction log register 45 that maintains a log of all relevant transactions with other devices 10, 20.

The server 40 may also include a real time or other clock 46. In general, the expression “clock” is intended to include any transaction counter or mechanism marking temporally spaced events in a time domain of the server, which may be independent of the time domains of either or both of the first and second devices.

In preferred embodiments, the first device 10 may be a portable cardkey type device for allowing a user access to a facility, premises or resource, such as a building, restricted area, computer resource or the like. In such a case, the second device 20 may be an access control device such as an electronic door lock, gate lock, equipment control system or a computer system.

In a general aspect, the access control device may be any device which effectively provides a transaction service to the first device, which service may include access to physical entities or virtual entities such as data, program code, computing resource or financial services. The server 40 may be a central control computer effecting access control for the entire building, facility or resource. In preferred arrangements, the server 40 is an independent auditor, witness, timekeeper or log keeper. It may also form part of the same system as that of the second device. It may also be operated and/or owned by a trusted third party organisation completely independent of the owners and/or operators of the first and second devices.

In another embodiment, the first device 10 may be a portable user identification device, such as a smartcard, credit card, debit card or the like, and the second device 20 may be a vending machine, retail point of sale terminal or other commercial transaction recording device. The server 40 may be a credit authorisation computer system.

In another embodiment, the first device 10 may be a computer or data processing device seeking to retrieve data from the second device, which could be a database or server.

Turning now to FIG. 2, a first transaction procedure 50 will now be described.

In a first step, the first device 10 issues a request 51 to the second device 20 initiating a transaction between the two devices. The request may include a transaction type specifier (indicating the type of transaction requested) and identification data identifying the originating device 10.

In a second step, the second and first devices may generally communicate to an extent necessary to determine the nature of the transaction required and any data essential thereto, to establish the necessary authorisation required, and any other communication as required. For convenience, this step will generally be referred to as an authentication/negotiation stage 52, but this is not to imply any limitation on the information flow effected.

This stage of the transaction may include processing of any data necessary by either device, and the data transmitted between the devices may be encrypted, unencrypted or a combination of both. The data may be accompanied by a digital signature of the sending device, if desired. It will be understood that, for the purposes of the present invention, the exact details of the transaction are not essential.

In a third step, the first device 10 generates a partial log message 53 for transmission to the second device 20. The partial log message 53 effectively contains any data that are required to adequately record details of the transaction in a transaction log, but particularly including data identifying the first device and event data relating to the transaction. The partial log 53 may be transmitted to the second device 20 in an encrypted and/or signed form, but need not be so.

In a fourth step, the second device 20 receives the partial log message 53 from the first device 10 and verifies that it is satisfied with the contents as being a correct representation of the transaction details.

If necessary, the second device may add further identification data (eg. its own identity) and/or further event data relating to the transaction, if this is not already present in the partial log 53.

If necessary, the second device may change information provided by the first device if it is not satisfied with the contents of the partial log message 53 provided by the first device.

The second device thereby generates a full log message 54 for transmittal to the first device. Prior to sending the full log message, the second device appends a digital signature to the full log message thereby ensuring the security of the full log message, and indicating its approval of the contents.

It will be understood that the application of a signature may include encryption of the entire message. However, in a general aspect, the signed full log includes identification data and event data for the transaction secured by a first digital signature that is specific to the second device 20. This ensures that the signed full log 54 received by the first device can be verified for authenticity and data integrity.

Upon receipt of the signed full log 54, the first device 10 verifies the integrity of the signed full log using the digital signature, and then re-signs the full log 54 to generate a re-signed full log 55 to be transmitted to the second device.

It will be understood that, in the verification of the signed full log 54, the first device should check that it agrees with any additions/deletions/changes to the partial log 53 that have been made by the second device, prior to re-signing the full log to generate the re-signed full log 55.

It will be understood that the application of the second digital signature by the first device may include encryption of the entire message. However, in a general aspect, the re-signed full log 55 includes the original identification data and event data for the transaction as secured by the first digital signature that is specific to the second device 20, and then secured by a second digital signature that is specific to the first device 10. This ensures that the re-signed full log 55 received by the second device can be verified as authentic and having data integrity by the second device.

The re-signed full log 55 is stored in memory 25 by the second device. Either the re-signed full log 55, or the signed full log 54 is stored in memory 15 by the first device.

It will recognised that, at this point, both the first and second devices 10, 20 have a copy of a transaction log 55, 56 that is verified as a true account of the transaction by both parties. No corruption of, or interference with, this data is possible by either party or by an independent third party without the corruption being evident to either device that signed or re-signed the transaction log.

In typical embodiments, the transaction being effected (eg. obtaining of access to a resource by the first device) may be prohibited from completion until such time as the second device receives a re-signed full log 55. Upon receipt of the re-signed full log, the second device may authorise the necessary action that completes the transaction 56.

Where the transaction relates to access control, the re-signed transaction log 55 may include identification data identifying the accessing party and the controlling party, and event data indicating the location of the access to the restricted resource, the time and date of the access, the authorisation level used for the access, and any other important transaction information.

Where the transaction relates to the purchase of commodities, either from a vending machine or a point of sale terminal, the re-signed transaction log may include identification data identifying both parties to the transaction, and event data indicating the location of the sale, the amount of the sale and/or the commodities purchased.

Preferably, the signed log and/or the re-signed log will include a unique identification code that can be referenced.

In a variation in the procedure of FIG. 2, the first device 10 may disagree with the contents of the signed full log 54. This could be as a result of additions, amendments or deletions made to the partial log 53 by the second device 20, or because the first device cannot verify the authenticity of the digital signature applied to the signed full log by the second device.

In this instance, the first device may issue a further partial log, which could be the same as the first partial log, or preferably a revised partial log that incorporates changes consequent on the data received from the second device in the signed full log 54. In any event, this procedure will initiate a further step of generating a second signed full log 54 by the second device. There is no practical limit to the number of times that the steps of generating a partial log 53 and a signed full log 54 can be repeated during a negotiation process in which the first and second devices try to agree upon a log.

Protocols may be implemented for ascertaining how to reach an agreement in the event that conflicts occur between the first and second devices. Similarly, protocols may be implemented for determining when to abort attempts to reach agreement and abandon the transaction.

With reference to FIG. 3 a more complex second transaction procedure 60 will now be described.

Like the first transaction procedure 50, in a first step, the first device 10 issues a request 61 to the second device 20 initiating a transaction between the two devices.

Again, like the first transaction procedure 50, in a second step, the second and first devices may generally communicate to an extent necessary to determine the nature of the transaction required and any data essential thereto, to establish the necessary authorisation required, and any other communication as required. For convenience, this step is again referred to as an authentication/negotiation stage 62, but this is not to imply any limitation on the information flow effected.

This stage of the transaction may include processing of any data necessary by either device, and the data transmitted between the devices may be encrypted, unencrypted or a combination of both. The data may be accompanied by a digital signature of the sending device, if desired. It will be understood that, for the purposes of the present invention, the exact details of the transaction are not essential.

In a third step, the first device 10 generates a partial log message 63 for transmission to the second device 20. The partial log message 63 effectively contains any data that are required to adequately record details of the transaction in a transaction log, but particularly including data identifying the first device and event data relating to the transaction. The partial log 63 may be transmitted to the second device 20 in an encrypted and/or signed form, but need not be so.

Device 20 examines the partial log, and may add to, remove from or edit data in the log as required. For example, device 20 may add its own device identification, timing information, etc.

At this point, the procedure departs from that of FIG. 2. In a fourth step, the second device 20 generates a fill log request 64 to a third party server 40. The fill log request generally comprises the contents of the partial log 63 (possibly as edited by device 20) and a request for third party data for inclusion in the transaction log.

The fill log request 64 may include a request for an independent verified time stamp from a trusted third party, where a time stamp is important to verify the transaction. This may be desirable to ensure evidence of any tampering with the internal clocks of either one or both of the first or second devices 10, 20 during execution of the transaction.

The fill log request 64 may include a request for an authorisation code from the server 40. For example, where the transaction relates to purchase of a commodity by credit card, the authorisation code may be the credit card provider's transaction authorisation for an amount of credit established during the transaction. It will be understood that, in a general aspect, the fill log request may be considered as equivalent to a partial log request from the second device to a server or third device.

In a fifth step, the server 40 returns a signed log 65 to the second device 20, the signed log including the requested information from the server. The information (eg. the trusted third party time stamp, or the transaction authorisation code) is secured by appending a digital signature of the server to the log returned to the second device 20. The signed log may include identification data identifying the server 40. The signed log 65 may be encrypted or unencrypted. The server may generally add, subtract or alter data in the fill log request 64 prior to generating a signed log 65.

In a sixth step, the second device 20 receives the signed log message 65 from the server 40 and verifies that it is satisfied with the contents as being a correct representation of the transaction details and that the message is authentic using the digital signature from the server. If necessary, the second device may add further identification data (eg. its own identity) and/or further event data relating to the transaction, providing that it does not interfere with any portion of the log that is signed by the server, since that would invalidate any such portion of the log signed by the server. The second device 20 thereby generates a full log message 66 for transmittal to the first device 10. Prior to sending the full log message, the second device appends a digital signature to the full log message thereby ensuring the security of the full log message 66, and indicating its approval of the contents.

The second device should not, however, interfere with the data provided by the server 40 if it is in agreement with it. It is necessary that the integrity and authenticity of the server-provided data can be verified by the first device. If the second device is not in agreement with data provided by the server 40 in the signed log 65, the second device can repeat a fill log request 64, abort the transaction, or initiate a restarting of the transaction, according to any suitable defined protocol.

It will be understood that the application of a signature may include encryption of the entire message. However, in a general aspect, the signed full log message 66 includes identification data and event data for the transaction, secured by a digital signature specific that is to the server 40, and further secured by digital signature that is specific to the second device 20. This ensures that the signed full log received by the first device can be verified as authentic and having data integrity with respect to both data elements that have originated from the server and from the second device.

Upon receipt of the signed full log 66, the first device 10 verifies the integrity of the signed full log using the digital signatures, and checks that it agrees with the content of the log. It then re-signs the full log to generate a re-signed full log 67 to be transmitted to the second device 20.

It will be understood that the application of the digital signature by the first device 10 may include encryption of the entire message. However, in a general aspect, the re-signed full log 67 includes the original identification data and event data for the transaction as secured by the digital signature that is specific to the server 40, the digital signature that is specific to the second device 20, and the digital signature that is specific to the first device 10.

The re-signed full log 67 is stored in memory 25 by the second device. Preferably, the re-signed full log 67, or possibly the signed full log 66, is stored in memory 15 by the first device. However, if only the signed full log 66 is stored by the first device, that does not provide subsequent evidence in the domain of the first device that the final log was agreed, except by its stored presence in the first device.

It will recognised that, at this point, both the first and second devices 10, 20 have a copy of a transaction log 66, 67 that includes third party trusted information or, more generally, server information, that is also verified as a true account of the transaction by both parties. No corruption of, or interference with, this data is possible by either party or by an independent third party without the corruption being evident to either device that signed or re-signed the transaction log.

If it is necessary or desirable to do so, the re-signed full log 67 may also be forwarded to the server 40 to maintain an independent secure log of the transaction.

In other respects, the second transaction procedure 60 is similar to the first transaction procedure.

In typical embodiments, the transaction being effected (eg. obtaining of access to a resource by the first device) may be prohibited from completion until such time as the second device receives a re-signed full log 67. Upon receipt of the re-signed full log, the second device may authorise the necessary action that completes the transaction 68.

It will be understood that a variation in the procedure of FIG. 3, where the first device disagrees with additions, amendments or deletions made by the second device when generating the signed full log, can be effected in an analogous fashion to that already described in connection with FIG. 2. The first device can re-issue a revised partial log 63 and the third, fourth, fifth and sixth steps repeated. Of course, if the content of the signed full log that has been provided by the server 40 is not disputed, it may not be necessary to repeat the fourth and fifth steps (fill log request message 64 and signed log message 65), merely repeating the third and sixth steps.

It will be understood that in some very simple transactions, the initial request 51, 61 might be incorporated into the partial log message 53, 63. In this instance, the authentication/negotiation stage 52 may effectively also be incorporated into the partial log message 53, 63 and the signed full log message 54, 66.

In preferred embodiments, the partial log message 53, 63 may include one or more of: a unique device identifier for the first device 10; an indication of the authorisation level of device 10; a first transaction identifier; a specification of the transaction type; a time of the transaction according to a clock in the time domain of the first device; any other data specific to the transaction.

In preferred embodiments, the signed full log message 54, 66 may include one or more of: the information of the partial log message; a unique device identifier for the second device 20; a second transaction identifier; a time of the transaction according to a clock in the time domain of the second device; any other data specific to the transaction.

In preferred embodiments, the signed full log message 66 may also include secured data from the server 40 including one or more of: independent time and/or date information according to the time domain of the server; a transaction identifier; an authorisation code; any other data specific to the transaction.

In some circumstances, it may be desirable to provide notification of the precise time at which access is granted, ie. the time at which the transaction completes. This can be effected by way of separate messages which are issued by the second device using secured or unsecured data.

With reference to FIG. 4, in one preferred embodiment for use in home security, the first device 10 may be a cardkey for access to a building, the second device 20 may be an electronic lock, and the server 40 may be a computer coupled to the second device, and preferably also to the internet. The communication channel 30 between the key 10 and the lock 20 may be direct electrical communication. The communication channel 31 between the electronic lock 20 and the computer 40 may be by wireless (eg. Bluetooth) link.

The cardkey 10 may be used by an authorised person, such as a gardener or domestic assistant. The electronic lock 20 will determine whether access to the premises to that person is accepted. In a first arrangement, the access may be granted autonomously by the electronic lock, and a log of the transaction (entry of the person to the building) recorded both in the electronic lock and in the cardkey. The electronic lock 20 may also communicate the transaction to the computer 40, which may be accessible to a homeowner 45 or building supervisor remotely via the internet.

In a second arrangement, the electronic lock 20 may not be able to grant access autonomously, but may need to obtain a transaction authorisation from the server 40. This authorisation might be granted by the computer (which may be remotely configurable via the internet) or the authorisation may need real time approval from the homeowner 45 or building supervisor. In this instance, the computer 40 may communicate with the homeowner 45 via internet e-mail, mobile telephony, or text messaging.

It will be understood that the principle of the invention can be extended to more devices, eg where three or more devices are party to a transaction. In this case, each device has the opportunity to verify a digitally signed copy of the transaction log from each of the other devices party to the transaction.

For example, referring again to FIG. 3, one implementation using multiple parties is now described. After receiving a fill log request 64 and adding any information to the partial log that is required, the server 40 may pass this partial log (that is, make a further fill log request 64) onto a second server. This second server would add its information to the log, sign it and return it as a signed log 66 to the first server 40. The first server 40 could then validate the signed log from the second server, sign it itself, and return the log to the second device 20. This would not affect the overall process from the point of view of the first and second devices 10 and 20. This process could also be repeated for any number of nested third parties.

A multiple party arrangement could also be implemented in respect of first, second and third (or more) devices, extending the embodiment of FIG. 2. For example, one such device (for example, the second device 20) could forward multiple parallel partial logs to other parties for verification and signature and compile all signed logs received from each other party into one signed full log 66 message for return to the first device. This parallel approach would ensure agreement of the whole log by two of the parties, but not the other parties.

Full agreement of the log by all parties could be effected in an N-device transaction log by way of a series approach to the set of messages. A first device issues a partial log to a second device, and this is passed consecutively to every other device to amend or add to in a forward direction 1 . . . N. At the end of the chain, the Nth device signs the log and returns the full log to each of the N-1 devices consecutively in the reverse direction. Once the first device has received the full log signed by all parties, it may pass the re-signed log 67 back down the chain in a forward direction.

Other embodiments are intentionally within the scope of the accompanying claims.

1. A method of generating a secure transaction log recording transaction data established between a first (10) and a second (20) data processing device, comprising the steps of:
the first device issuing a partial transaction log (63) to the second device, the partial transaction log including identification data and event data associated with the transaction;
the second device issuing to the first device, in response to the partial transaction log, a signed full log (66), the signed full log including said identification data and event data, secured by a first digital signature specific to the second device (20); and
the first device issuing, in response to the signed full log (66), a re-signed full log (67) including said identification data, said event data and said first digital signature, secured by a second digital signature specific to the first device.

2. The method of claim 1 further including, prior to the step of issuing the partial transaction log (63), the step of:
establishing communication (61,62) between the first and second devices in order to effect a transaction and generate data associated with that transaction, at least some of the data so generated being used as said event data in said partial transaction log.

3. The method of claim 2 in which the transaction includes authentication (62) of the identity of at least one of the devices.

4. The method of claim 1 in which the event data includes time stamp information derived from at least one of the first device (10) and the second device (20).

5. The method of claim 1 in which the event data and/or the further event data includes time stamp information derived from both the first device (10) and the second device (20).

6. The method of claim 1 in which the identification data includes data uniquely identifying the first device (10) and/or the second device (20).

7. The method of claim 1 in which the signed full log includes further event data added by the second device (20).

8. The method of claim 1 in which at least one or more of: the partial log; the signed transaction log; and the re-signed transaction log are encrypted during transfer between the first (10) and second (20) devices.

9. The method of claim 1 in which the first digital signature is applied using a private key of the second device, the counterpart public key being accessible to the first device.

10. The method of claim 1 or claim 9 in which the second digital signature is applied using a private key of the first device, the counterpart public key being accessible to the second device.

11. The method of claim 1 further including the steps of:
issuing a data request (64) to a third device (40), by the second device (20), after receiving the partial transaction log (63) from the first device;
receiving (65) third party event data, by the second device from the third device (40) in response to the data request;
including the third party event data into the signed full log (66) issued to the first device.

12. The method of claim 11 in which the third party event data is secured by a third digital signature specific to the third device (40).

13. The method of claim 11 in which the third party event data includes time stamp information independent of the first and second devices.

14. The method of claim 11 in which the third party event data includes transaction authorisation data.

15. The method of claim 12 in which the third digital signature is applied using a private key of the third device (40), the counterpart public key being accessible to the first (10) and second (20) devices.

16. The method of claim 1 in which the first device (10) is a portable identification device and the second device (20) is an access control device for controlling access to a building, facility or resource.

17. The method of claim 1 or claim 11 in which the signed full log includes the contents of the partial transaction log modified by the second device.

18. The method of claim 1 or claim 11 further including the steps of:
the first device (10) issuing a revised transaction log to the second device, after receiving the signed full log (66), the revised partial log comprising the contents of the signed full log modified by the first device; and
the second device (20) issuing to the first device, in response to the revised partial log a revised signed full log secured by a digital signature specific to the second device.

19. The method of claim 18 further including repeating the steps of issuing a revised partial transaction log and a revised signed full log until both the first and second devices are in agreement with the contents of the transaction log.

20. A method of operating an access control device (20) to generate a secure transaction log recording transaction data established between a first device (10) and the access control device (20), comprising the steps of:
receiving from the first device, a partial transaction log (63), the partial transaction log including identification data and event data associated with the transaction;
issuing to the first device, in response to the partial transaction log, a signed full log (66), the signed full log including said identification data and event data, secured by a first digital signature specific to the access control device; and
receiving, from the first device, in response to the signed full log, a re-signed full log (67) including said identification data, said event data and said first digital signature, secured by a second digital signature specific to the first device.

21. The method of claim 20 further including the steps of:
issuing a data request (64) to a third device, after receiving the partial transaction log (63) from the first device;
receiving third party event data (65), from the third device in response to the data request;
including the third party event data into the signed full log (66) issued to the first device.

22. The method of claim 20 or claim 21 in which the signed full log includes the contents of the partial transaction log modified by the second device (20).

23. The method of claim 20 or claim 21 further including the steps of:
the first device (10) issuing a revised partial transaction log to the second device, after receiving the signed full log (66), the revised partial log comprising the contents of the signed full log modified by the first device; and
the second device (20) issuing to the first device, in response to the revised partial log a revised signed full log secured by a digital signature specific to the second device.

24. The method of claim 23 further including repeating the steps of issuing a revised partial transaction log and a revised signed full log until both the first (10) and second (20) devices are in agreement with the contents of the transaction log.

25. The method of claim 20 further including the step of verifying the authenticity and integrity of the re-signed full log using a public key of the first device.

26. The method of claim 20 or claim 21 in which the access control device (20) is any of an electronic door lock, electronic gate lock, equipment control system, computer system, data processing or retrieval system, point of sale terminal, or vending machine, and in which the first device (10) is any of an electronic key, credit or debit card.

27. The method of claim 20 further including the step of allowing the first device (10) access to a predetermined resource, by the access control device (20), only after receipt of the re-signed log by the access control device.

28. A method of operating a first data processing device to generate a secure transaction log recording transaction data established between the first device (10) and a second data processing device (20), comprising the steps of:
issuing a partial transaction log (63) to the second device, the partial transaction log including identification data and event data associated with the transaction;
receiving from the second device, in response to the partial transaction log, a signed full log (66), the signed full log including said identification data and event data, secured by a first digital signature specific to the second device; and
issuing, in response to the signed full log, a re-signed full log (67) including said identification data, said event data and said first digital signature, secured by a second digital signature specific to the first device.

29. The method of claim 28 further including the step of verifying the authenticity and integrity of the signed full log using a public key of the second device.

30. A computer program product, comprising a computer readable medium having thereon computer program code means adapted, when said program is loaded onto a computer, to make the computer execute the procedure of any one of claims 20 to 29.

31. Apparatus for generating a secure transaction log recording transaction data established between a first (10) and a second (20) data processing device, comprising:
means (11), in the first device, for issuing a partial transaction log to the second device, the partial transaction log including identification data and event data associated with the transaction;
means (21), in the second device, for issuing to the first device, in response to the partial transaction log, a signed full log, the signed full log including said identification data and event data, secured by a first digital signature specific to the second device; and
means (11), in the first device, for issuing, in response to the signed full log, a re-signed full log including said identification data, said event data and said first digital signature, secured by a second digital signature specific to the first device.

32. An access control device (20) adapted to generate a secure transaction log recording transaction data established between a first device (10) and the access control device, comprising:
means (21,25) for receiving from the first device, a partial transaction log, the partial transaction log including identification data and event data associated with the transaction;
means (21) for issuing to the first device, in response to the partial transaction log, a signed full log, the signed full log including said identification data and event data, secured by a first digital signature specific to the access control device; and
means (21) for receiving, from the first device, in response to the signed full log, a re-signed full log including said identification data, said event data and said first digital signature, secured by a second digital signature specific to the first device.

33. A data processing device (10) adapted to generate a secure transaction log recording transaction data established between the data processing device and a second data processing device (20), comprising:
means (11,15) for issuing a partial transaction log to the second device, the partial transaction log including identification data and event data associated with the transaction;
means (11) for receiving from the second device, in response to the partial transaction log, a signed full log, the signed full log including said identification data and event data; secured by a first digital signature specific to the second device; and
means (11) for issuing, in response to the signed full log, a re-signed full log including said identification data, said event data and said first digital signature, secured by a second digital signature specific to the data processing device.
